(19) United States
(12) Patent Application Publication
(10) Pub. No.: US 2024/0040679 A1
(43) Pub. Date: Feb. 1, 2024

(54) LED DRIVING SYSTEM AND METHOD

(71) Applicant: JADE BIRD DISPLAY (SHANGHAI) LIMITED, SHANGHAI (CN)

(72) Inventor: Hongyun LIU, Shanghai (CN)

(21) Appl. No.: 18/360,973

(22) Filed: Jul. 28, 2023

(30) Foreign Application Priority Data
Aug. 1, 2022 (WO) PCT/CN2022/109358

(51) Int. Cl. H05B 45/10; H05B 45/325

(52) U.S. Cl. CPC H05B 45/10; H05B 45/325

(57) ABSTRACT

An LED driving system includes a converting circuit, configured to convert a first voltage to a second voltage, having a voltage difference from the first voltage based on a control input; a driving circuit coupled to the converting circuit to receive the second voltage and configured to generate an output signal based on the second voltage; and a controlling circuit coupled to the driving circuit and configured to control a luminance of an LED based on the output signal.

### CROSS-REFERENCE TO RELATED APPLICATIONS

The present disclosure claims priority to and the benefits of PCT Application No. PCT/CN2022/109358, filed on Aug. 1, 2023, which is incorporated herein by reference in its entirety.

### TECHNICAL FIELD

The present disclosure generally relates to display technology, and more particularly, to an LED driving system and method.

### BACKGROUND

The gray scale of an LED display mainly determines a gray scale level of brightness, with which content, such as pictures and video images, is displayed. Luminance is a measurable quality of light corresponding to brightness. A luminance of each LED pixel is adjustable, and a fineness of the adjustment is the grayscale level of the display. The higher the grayscale level, i.e., the higher the number of levels of luminance, the more delicate and colorful the displayed image can be.

A light-emitting unit includes red, green, and blue LEDs and driving circuits. Driving chips that are commonly used to provide driving circuits include chips with built-in serial-parallel shift register units and output latch units. Control input signals of the driving chips include data (R, G, B), a shift pulse (e.g., provided by a clock (CLK)), a latch pulse (e.g., provided by a strobe), and so on.

Generally, a scheme of linearly adjusting a current of the LED is used to change its luminance. A method for adjusting gray scales of the LED by adjusting a number of pulses is also disclosed. However, the grayscale level needs to be finely adjustable for a better display effect.

### SUMMARY OF THE DISCLOSURE

Embodiments of the present disclosure provide an LED driving system. The LED driving system includes a converting circuit, configured to convert a first voltage to a second voltage, having a voltage difference from the first voltage based on a control input; a driving circuit coupled to the converting circuit to receive the second voltage and configured to generate an output signal based on the second voltage; and a controlling circuit coupled to the driving circuit and configured to control a luminance of an LED based on the output signal.

Embodiments of the present disclosure also provide an LED driving method. The method includes converting a first voltage to a second voltage having a voltage difference from the first voltage based on a control input; generating an output signal based on the second voltage; and controlling a luminance of an LED based on the output signal.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a diagram structure of an exemplary LED driving system, according to some embodiments of the present disclosure.

FIG. 2 illustrates an exemplary relationship between a second voltage and an output signal, according to some embodiments of the present disclosure.

FIG. 3 illustrates an exemplary relationship between an input PWM signal and an output signal, according to some embodiments of the present disclosure.

FIG. 4 illustrates another exemplary relationship between the second voltage and the output signal, according to some embodiments of the present disclosure.

FIG. 5 illustrates another diagram of structure of an exemplary LED driving system, according to some embodiments of the present disclosure.

FIG. 6 illustrates a flowchart of an exemplary LED driving method, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

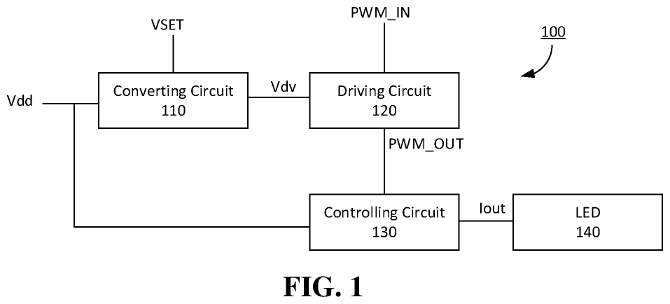

FIG. 1 illustrates a diagram of structure of an exemplary LED driving system 100, according to some embodiments of the present disclosure. Referring to FIG. 1, the LED driving system 100 includes a converting circuit 110, a driving circuit 120, a controlling circuit 130, and an LED 140. An input of driving circuit 120 is coupled to an output of converting circuit 110. A first input of controlling circuit 130 is coupled to an output of driving circuit 120, and an output of controlling circuit 130 is coupled to LED 140 to control a luminance (e.g., grayscale) of LED 140. In some embodiments, converting circuit 110 and controlling circuit 130 are both coupled to a working voltage Vdd. In some embodiments, converting circuit 110 may include a control input pin(s) VSET for receiving as input a plurality of bits representing a control input. Converting circuit 110 may be realized by a chip.

Converting circuit 110 is configured to convert a first voltage, the working voltage Vdd, to a second voltage Vdv based on a control input received on pin(s) VSET. The second voltage Vdv has a voltage difference Vgs with the first voltage Vdd. The first voltage Vdd, i.e., a working voltage, can be, for example, +5V. The second voltage Vdv is lower than the first voltage Vdd, for example, in the range from +2V to +3V. When the range of the second voltage Vdv is determined, a variation range of the voltage difference Vgs is determined, Vgs=Vdd−Vdv. In this example, the variation range of the voltage difference Vgs is in a variation interval of 1V, i.e., 3V−2V=1V. The variation range of the voltage difference Vgs can be quantized and adjusted in response to the control input. Therefore, different values of the second voltage Vdv can be generated by adjusting the control input at different levels. In some embodiments, the control input is set by a number of bits, for example, the control input is configured by the pin(s) VSET of a chip. The VSET pins can be configured to receive 8 bits, 10 bits, or 12 bits, etc., that represent the control input. The VSET is a multi-bit input, and the control input can be received as a binary combination. For example, for an 8 bits input, the VSET<7:0> can be from (00000000) to (11111111). In this example, if the variation range of 1V of the voltage difference Vgs is quantized by 8 bits (e.g., the pin(s) VSET configured to receive is a pin with 8 bits), the voltage difference range (e.g., 1V) is divided into 256 levels and the voltage variation of each level is 1/256V. Correspondingly, the converting circuit 110 can convert and output 256 voltage values of the second voltage Vdv. For example, when VSET<7:0>=(00000000), the voltage difference Vgs is with a smallest value, for example, 2V. When VSET<7:0>=(111111111), the voltage difference Vgs is with a greatest value, for example, 3V. In some embodiments, if the variation range of 1V of the voltage difference Vgs is quantized by 10 bits, the voltage difference range is divided into 1024 levels, and the voltage variation of each level is 1/1024 V. Correspondingly, the converting circuit 110 can convert and output 1024 voltage values of the second voltage Vdv. In some embodiments, if the variation range of 1V of the voltage difference Vgs is quantized by 12 bits, the voltage difference range is divided into 4096 levels, and the voltage variation of each level is 1/4096V. Correspondingly the converting circuit 110 can convert and output 4096 voltage values of the second voltage Vdv. Therefore, the converting circuit 110 can convert and output the second voltage Vdv to different magnitudes based on the control input.

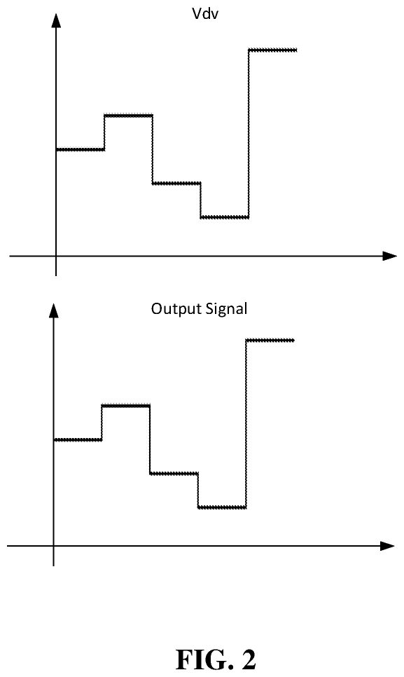

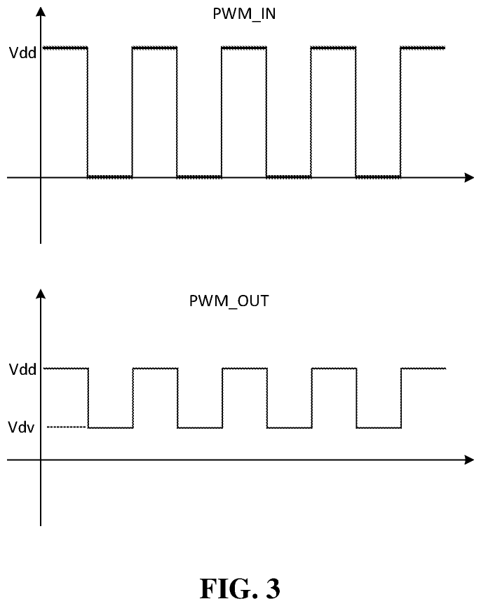

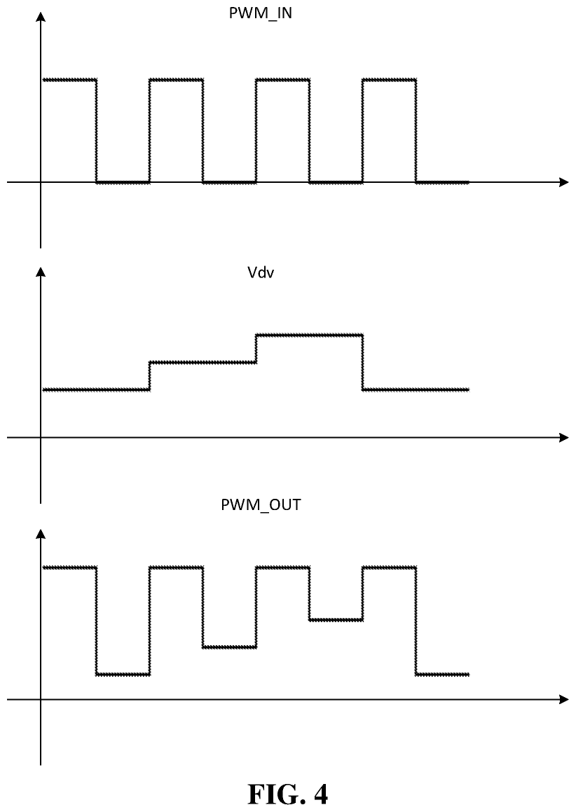

Driving circuit 120 is coupled to converting circuit 110 and configured to generate an output signal based on the second voltage Vdv. For example, the output signal of driving circuit 120 changes as a function of the second voltage Vdv. For example, FIG. 2 illustrates an exemplary relationship between the second voltage Vdv and the output signal of driving circuit 120, according to some embodiments of the present disclosure. As shown in FIG. 2, a voltage of the output signal of driving circuit 120 follows the second voltage Vdv. When the second voltage Vdv increases, the output signal increases; and when the second voltage Vdv decreases, the output signal decreases. In some embodiments, the output signal of driving circuit 120 can be a digital signal, for example, a pulse width modulation (PWM) signal. Referring again to FIG. 1, driving circuit 120 is coupled to receive input PWM signal PWM_IN. Driving circuit 120 is configured to determine an output signal PWM_OUT based on the input signal PWM_IN and the second voltage Vdv. A duty cycle of the output signal PWM_OUT is determined based on the input signal PWM_IN. The high level of the output signal PWM_OUT can be the same as the voltage of the input signal PWM_IN, in this example, the voltage of PWM_IN is the same as the working voltage Vdd. In some embodiments, the voltage of PWM_IN can be different from the working voltage Vdd. The low level of the output signal PWM_OUT is determined based on the working voltage Vdd and the second voltage Vdv. FIG. 3 illustrates an exemplary relationship between the input PWM signal and the output signal PWM_OUT, according to some embodiments of the present disclosure. As shown in FIG. 3, the output signal PWM_OUT has a same duty cycle and frequency as the duty cycle and frequency of the input signal PWM_IN. The high level of the output signal PWM_OUT is equal to the working voltage Vdd, and the low level of the output signal PWM_OUT is equal to the second voltage Vdv. FIG. 4 illustrates another exemplary relationship between the second voltage Vdv and the output signal PWM_OUT, according to some embodiments of the present disclosure. More particularly, FIG. 4 shows the input signal PWM_IN, second voltage Vdv, and output signal PWM_OUT. As show in FIG. 4, the low level of the output signal PWM_OUT changes with the second voltage Vdv. As discussed above, since the second voltage Vdv can be adjusted to different magnitudes, the output signal PWM_OUT can be changed to different magnitudes.

In some embodiments, the duty cycle of the output signal PWM_OUT is adjustable within one pulse cycle, that is, the ratio of the output high level Vdd and the output low level Vdv within one pulse cycle can be adjusted. For example, the duty cycle of the output signal PWM_OUT is adjusted by adjusting the duty cycle of the input signal PWM_IN. Therefore, the luminance of the LED can be also controlled by the adjustment.

Referring back to FIG. 1, controlling circuit 130 is coupled to driving circuit 120 and configured to control the luminance (e.g., grayscale for a display) of LED 140 based on the output signal PWM_OUT. Controlling circuit 130 generates an output current Iₒᵤₜ based on the output signal. The output current Iₒᵤₜ can control the luminance of LED 140. When the output current Iₒᵤₜ is low, the luminance of LED 140 is low; when the output current Iₒᵤₜ is high, the luminance of LED 140 is high. The more levels at which of the output current Iₒᵤₜ can be generated by controlling circuit 130, the greater fineness of the grayscale level can be realized. Since the output signal PWM_OUT can be changed to different magnitudes, for example, in 256 levels, 1024 levels, or 4096 levels, the output current Iₒᵤₜ which is generated based on the output signal PWM_OUT, can also adjusted to different magnitudes (e.g., levels). With the numerous levels for the output current Iₒᵤₜ to control the luminance of LED 140, the fineness for display is significantly improved.

In some embodiments, controlling circuit 130 can further connect to the working voltage Vdd. The output current Iₒᵤₜ is determined by comparing the output signal and the working voltage Vdd. In this example, since the variation range of the voltage difference Vgs between the working voltage Vdd and the second voltage Vdv is quantized to multiple levels and the low level of the output signal PWM_OUT is equal to Vdv, the output current Iₒᵤₜ that is determined directly by the voltage difference Vgs can be quantized more accurate, thereby improving the fineness of the display.

In some embodiments, LED 140 can be an LED with any colors, for example, LED 140 is one of a white LED, a red LED, a blue LED, or a yellow LED.

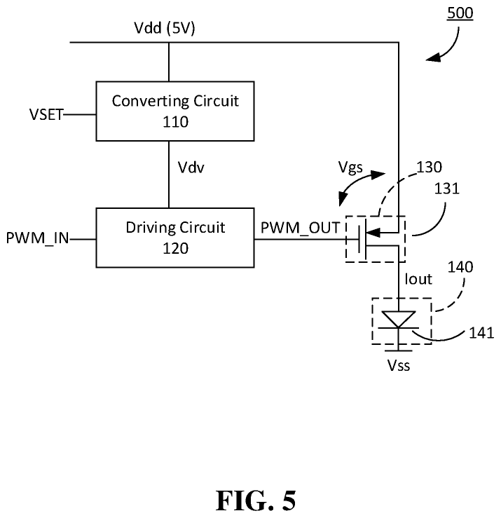

FIG. 5 illustrates another diagram of structure of an exemplary LED driving system 500, according to some embodiments of the present disclosure. Referring to FIG. 5, LED driving system 500 includes the previously described converting circuit 110 and driving circuit 120 configured as shown in FIG. 1. System 500 further includes controlling circuit 130 provided as a MOS (Metal-Oxide-Semiconductor) transistor 131. A source of MOS transistor 131 is coupled to the first voltage Vdd, a gate of MOS transistor 131 is coupled to an output of driving circuit 120, and a drain of MOS transistor 131 is coupled to LED 140. In system 500, LED 140 comprises a diode 141. The drain of MOS transistor 131 is coupled to a positive pole of diode 141. A negative pole of diode 141 is connected to a ground Vss. When the output signal PWM_OUT of driving circuit 120 is at a low level, Vgs=Vdd−Vdv, and MOS transistor 131 is turned on. By adjusting the configuration (e.g., a digital value) of VSET, the variation range of Vgs can be quantized to a large number of levels, for example, 256, 1024, 4096, etc. In system 500, the voltage difference Vgs between the source and gate of MOS transistor 131 is positively correlated to the output current Iₒᵤₜ flowing through LED 140. A different value of Iₒᵤₜ can be obtained by adjusting the voltage difference Vgs, and a different luminance can be produced when a different Iₒᵤₜ flows through LED 140. Converting circuit 110 is configured to adjust a low level Vdv of the output signal PWM_OUT, which can be quantized by 8 bits, 10 bits and 12 bits. Therefore, a very large number of low-level Vdv values can be obtained. Accordingly, luminance adjustment (e.g., grayscale of the picture display) becomes more precise. Driving circuit 120 is configured to adjust the duty cycle of the output signal PWM_OUT within one pulse cycle by adjusting the duty cycle of the input signal PWM_IN. By adjusting the duty cycle of the output signal PWM_OUT, the output current Iₒᵤₜ can be adjusted, thereby adjusting the luminance of LED 140.

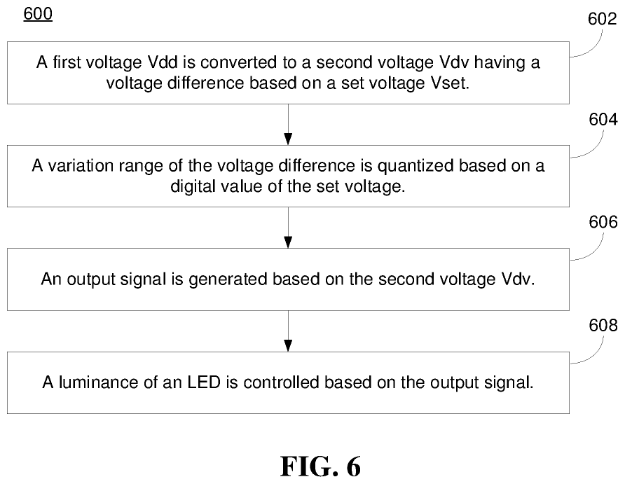

FIG. 6 illustrates a flowchart of an exemplary LED driving method 600, according to some embodiments of the present disclosure. Method 600 can be performed by LED driving system 100. As shown in FIG. 6, method 600 includes steps 602 to 608.

At step 602, a first voltage Vdd is converted to a second voltage Vdv having a voltage difference based on a control input. The second voltage Vdv has a voltage difference Vgs with the first voltage Vdd. The first voltage Vdd can be the working voltage, for example, +5V. The second voltage Vdv is lower than the first voltage Vdd, for example, in a range from +2V to +3V. When the range of the second voltage Vdv is determined, a variation range of the voltage difference Vgs is determined. In this example, the variation range of the voltage difference Vgs is in an interval of 1V, i.e., 3V−2V=1V.

At step 604, a variation range of the voltage difference is quantized based on a digital value of the control input. The variation range of the voltage difference Vgs can be quantized and adjusted by the control input. Therefore, different values of the second voltage Vdv can be generated by adjusting the control input. In some embodiments, the control input is set by a number of bits, for example, the control input is setting by a pin (or pins) VSET of a chip. The VSET can be a pin(s) with 8 bits, 10 bits, or 12 bits, etc., which can be determined by a chip selected. The VSET is a multi-bit input, and the control input can be received as a binary combination. For example, for an 8 bits input, the VSET<7:0> can be from (00000000) to (11111111). In this example, if the variation range of 1V of the voltage difference Vgs is quantized by 8 bits (e.g., the pin (or pins) VSET receives 8 bits), the voltage difference range (e.g., 1V) is divided into 256 levels and the voltage variation of each level is 1/256V. Correspondingly, the converting circuit 110 can convert and output 256 voltage values of the second voltage Vdv. If the variation range of 1V of the voltage difference Vgs is quantized by 10 bits, the voltage difference range is divided into 1024 levels, and the voltage variation of each level is 1/1024V. Correspondingly, converting circuit 110 can convert and output 1024 voltage values of the second voltage Vdv. If the variation range of 1V of the voltage difference Vgs is quantized by 12 bits, the voltage difference range is divided into 4096 levels, and the voltage variation of each level is 1/4096V. Correspondingly the converting circuit 110 can convert and output 4096 voltage values of the second voltage Vdv. Therefore, the converting circuit 110 can convert and output a second voltage Vdv having different magnitudes based on the control input.

At step 606, an output signal is generated based on the second voltage Vdv. For example, the output signal PWM_OUT is changed based on the second voltage Vdv. For example, a voltage of the output signal follows the second voltage Vdv, as shown in FIG. 2. When the second voltage Vdv increases, the output signal increases; and when the second voltage Vdv decreases, the output signal decreases. In some embodiments, the output signal can be a digital signal, for example, a PWM signal. An input PWM signal PWM_IN can be another input of driving circuit 120. The output signal PWM_OUT is determined based on the input signal PWM_IN and the second voltage Vdv. The duty cycle of the output signal PWM_OUT is determined based on the input signal PWM_IN. The high level of the output signal PWM_OUT can be the same as the voltage of the input signal PWM_IN. In this example, the voltage of PWM_IN is the same as the working voltage Vdd. In some embodiments, the voltage of PWM_IN can be different from the working voltage Vdd. The low level of the output signal PWM_OUT is determined based on the working voltage Vdd and the second voltage Vdv. For example, the output signal PWM_OUT may have the same duty cycle and frequency as the duty cycle and frequency of the input signal PWM_IN. The high level of the output signal PWM_OUT is equal to the working voltage Vdd, and the low level of the output signal PWM_OUT is equal to the second voltage Vdv, as shown in FIG. 3. In some embodiments, the low level of the output signal PWM_OUT changes with the second voltage Vdv, as shown in FIG. 4. As discussed above, since the second voltage Vdv can be adjusted to different magnitudes, the output signal can be changed to different magnitudes.

In some embodiments, the duty cycle of the output signal PWM_OUT is adjustable within one pulse cycle, that is, the ratio of the output high level Vdd and the output low level Vdv within one pulse cycle can be adjusted. For example, the duty cycle of the output signal PWM_OUT is adjusted by adjusting the duty cycle of the input signal PWM_IN. Therefore, the luminance of the LED can be also controlled by the adjustment.

At step 608, a luminance of an LED is controlled based on the output signal. A current I_{LED} for LED 140 is based on the output signal, which can control the luminance of LED 140. When the current I_{LED} is low, the luminance of LED 140 is low; when the current I_{LED} is high, the luminance of LED 140 is high. The more levels that the current I_{LED} can have, the higher fineness the grayscale level reaches. The luminance of LED 140 is positively correlated with the current I_{LED}. Since the output signal can be changed to different magnitudes, for example, 256 levels, 1024 levels, or 4096 levels, the current I_{LED} which is generated based on the output signal, can also adjusted to different magnitudes (e.g., levels). With the numerous levels for the current LED to control the luminance of LED 140, the fineness of display is significantly improved.

In some embodiments, the current I_{LED} is determined by comparing the output signal and the working voltage Vdd. In this example, since the variation range of the voltage difference Vgs between the working voltage Vdd and the second voltage Vdv is quantized to multiple levels and the low level of the output signal is equal to Vdv, the current I_{LED} that determined directly with the voltage difference Vgs can be quantized more accurate, thereby display is finer.

The embodiments may further be described using the following clauses:
1. An LED driving system, comprising:
a converting circuit, configured to convert a first voltage to a second voltage, having a voltage difference from the first voltage based on a control input;
a driving circuit coupled to the converting circuit to receive the second voltage and configured to generate an output signal based on the second voltage; and
a controlling circuit coupled to the driving circuit and configured to control a luminance of an LED based on the output signal.
2. The LED driving system according to clause 1, wherein a variation range of the voltage difference is quantized by a digital value of the control input.
3. The LED driving system according to clause 2, wherein when the variation range is quantized by 8 bits, the variation range is divided into 256 levels; when the variation range is quantized by 10 bits, the variation range is divided into 1024 levels; and when the variation range is quantized by 12 bits, the variation range is divided into 4096 levels.
4. The LED driving system according to any one of clauses 1 to 3, wherein the driving circuit is coupled to receive an input signal, the output signal being generated based on the input signal and the second voltage.
5. The LED driving system according to clause 4, wherein the input signal is an input pulse width modulation (PWM) signal, and the output signal is an output PWM signal.
6. The LED driving system according to clause 5, wherein the output PWM signal comprises a high level at the first voltage and a low level at the second voltage in a pulse cycle.
7. The LED driving system according to clause 5 or 6, wherein a duty cycle of the output PWM signal is adjustable within a pulse cycle.
8. The LED driving system according to any one of clauses 1 to 7, wherein the controlling circuit comprises a Metal-Oxide-Semiconductor (MOS) transistor, a source of the MOS transistor is coupled to receive the first voltage, a gate of the MOS transistor is coupled to an output of the driving circuit, and a drain of the MOS transistor is coupled to the LED.
9. The LED driving system according to clause 8, wherein the voltage difference between the first voltage and the second voltage is equal to a voltage difference between the source and gate of the MOS transistor.
10. The LED driving system according to clause 8 or 9, wherein the luminance of the LED is controlled based on a current output from the drain.
11. The LED driving system according to any one of clauses 1 to 10, wherein the LED is one of a white LED, a red LED, or a blue LED.
12. A LED driving method, comprising:
converting a first voltage to a second voltage, having a voltage difference from the first voltage based on a control input;
generating an output signal based on the second voltage; and
controlling a luminance of an LED based on the output signal.
13. The method according to clause 12, wherein after converting the first voltage to a second voltage based on a control input, the method further comprising:
quantizing a variation range of the voltage difference based on a digital value of the control input.
14. The method according to clause 13, wherein when the variation range of the voltage difference is quantized by 8 bits, the variation range is divided into 256 levels; when the variation range is quantized by 10 bits, the variation range is divided into 1024 levels; and when the variation range is quantized by 12 bits, the variation range is divided into 4096 levels.
15. The method according to any one of clauses 12 to 14, wherein generating the output signal based on the second voltage further comprises:
generating the output signal based on the second voltage and an input signal.
16. The method according to clause 15, wherein the input signal is an input pulse width modulation (PWM) signal, and the output signal is an output PWM signal.
17. The method according to clause 16, wherein the output PWM signal comprises a high level at the first voltage and a low level at the second voltage in a pulse cycle.
18. The method according to clause 16 to 17, wherein a duty cycle of the output PWM signal is adjustable within a pulse cycle.
19. The method according to any one of clauses 12 to 18, wherein after generating the output signal based on the second voltage, the method further comprises:
controlling a current of the LED based on the output signal; and
controlling the luminance of the LED based on the output signal further comprises:
controlling the luminance of the LED based on the current.
20. The method according to clause 19, wherein the luminance of the LED is positively correlated with the current.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. An LED driving system, comprising:
a converting circuit configured to convert a first voltage to a second voltage, having a voltage difference from the first voltage based on a control input;
a driving circuit coupled to the converting circuit to receive the second voltage and configured to generate an output signal based on the second voltage; and
a controlling circuit coupled to the driving circuit and configured to control a luminance of an LED based on the output signal.

2. The LED driving system according to claim 1, wherein a variation range of the voltage difference is quantized by a digital value of the control input.

3. The LED driving system according to claim 2, wherein when the variation range is quantized by 8 bits, the variation range is divided into 256 levels; when the variation range is quantized by 10 bits, the variation range is divided into 1024 levels; and when the variation range is quantized by 12 bits, the variation range is divided into 4096 levels.

4. The LED driving system according to claim 1, wherein the driving circuit is coupled to receive an input signal, the output signal being generated based on the input signal and the second voltage.

5. The LED driving system according to claim 4, wherein the input signal is an input pulse width modulation (PWM) signal, and the output signal is an output PWM signal.

6. The LED driving system according to claim 5, wherein the output PWM signal comprises a high level at the first voltage and a low level at the second voltage in a pulse cycle.

7. The LED driving system according to claim 5, wherein a duty cycle of the output PWM signal is adjustable within a pulse cycle.

8. The LED driving system according to claim 1, wherein the controlling circuit comprises a Metal-Oxide-Semiconductor (MOS) transistor, a source of the MOS transistor is coupled to receive the first voltage, a gate of the MOS transistor is coupled to an output of the driving circuit, and a drain of the MOS transistor is coupled to the LED.

9. The LED driving system according to claim 8, wherein the voltage difference between the first voltage and the second voltage is equal to a voltage difference between the source and gate of the MOS transistor.

10. The LED driving system according to claim 8, wherein the luminance of the LED is controlled based on a current output from the drain.

11. The LED driving system according to claim 1, wherein the LED is one of a white LED, a red LED, or a blue LED.

12. A LED driving method, comprising:
converting a first voltage to a second voltage, having a voltage difference from the first voltage based on a control input;
generating an output signal based on the second voltage; and
controlling a luminance of an LED based on the output signal.

13. The method according to claim 12, wherein after converting the first voltage to a second voltage based on a control input, the method further comprising:
quantizing a variation range of the voltage difference based on a digital value of the control input.

14. The method according to claim 13, wherein when the variation range of the voltage difference is quantized by 8 bits, the variation range is divided into 256 levels; when the variation range is quantized by 10 bits, the variation range is divided into 1024 levels; and when the variation range is quantized by 12 bits, the variation range is divided into 4096 levels.

15. The method according to claim 12, wherein generating the output signal based on the second voltage further comprises:
generating the output signal based on the second voltage and an input signal.

16. The method according to claim 15, wherein the input signal is an input pulse width modulation (PWM) signal, and the output signal is an output PWM signal.

17. The method according to claim 16, wherein the output PWM signal comprises a high level at the first voltage and a low level at the second voltage in a pulse cycle.

18. The method according to claim 16, wherein a duty cycle of the output PWM signal is adjustable within a pulse cycle.

19. The method according to claim 12, wherein after generating the output signal based on the second voltage, the method further comprises:
controlling a current of the LED based on the output signal; and
controlling the luminance of the LED based on the output signal further comprises:
controlling the luminance of the LED based on the current.

20. The method according to claim 19, wherein the luminance of the LED is positively correlated with the current.
